(19) United States
(12) Patent Application Publication
(10) Pub. No.: US 2013/0319469 A1
(43) Pub. Date: Dec. 5, 2013

(54) VACUUM NOZZLE

(71) Applicants: Richard Borges, SR., Clifton, NJ (US); Joanny Borges, Clifton, NJ (US)

(72) Inventors: Richard Borges, SR., Clifton, NJ (US); Joanny Borges, Clifton, NJ (US)

(21) Appl. No.: 13/485,868

(22) Filed: May 31, 2012

(51) Int. Cl. A47L 9/02; B08B 5/04; A47L 9/06

(52) U.S. Cl. 134/21; 15/415.1; 15/363

(57) ABSTRACT

A vacuum nozzle is angled to be able to vacuum both a floor portion and a floor molding at the same time. Unlike conventional vacuum nozzles that are flat, the nozzle as herein described is angled, typically at 90 degrees, to fit into the corner along where the wall meets the floor. The nozzle can also be used, for example, where the ceiling meets the wall, or any other such corner to provide a vacuum cleaning thereto.

### BACKGROUND OF THE INVENTION

The present invention relates to vacuum nozzles and, more particularly, to a vacuum nozzle that is angled to clean both the floor and corner molding at the same time.

When cleaning with a vacuum cleaner, it may be easy to clean the floor, but more difficult to clean the corner molding that is typically placed along a wall at the floor. Some vacuum nozzles may swivel and allow a user to vacuum a floor first, then swivel the head, and pass along the corner molding in a second pass. This however, takes time and requires a nozzle that can swivel. Without such a swiveling nozzle, a user may find themselves bent over and holding the vacuum at an awkward angle in order to vacuum the corner molding.

Moreover, conventional vacuum nozzles, while they may be designed to get as close to the corner as possible, can never get completely into a corner (between the floor and the wall corner molding) because there always needs to be a nozzle housing that provides a gap.

As can be seen, there is a need for an improved vacuum nozzle that is capable of cleaning both the floor and the corner molding at the same time, while also not leaving any gaps between the floor and the corner molding.

### SUMMARY OF THE INVENTION

In one aspect of the present invention, a vacuum nozzle comprises a vacuum hose receptacle for attaching a vacuum hose; and a nozzle member having an opening formed at a 90 degree angle, such that the opening is operable to be disposed against a floor and a wall simultaneously.

In another aspect of the present invention, a vacuum nozzle comprises a vacuum hose receptacle for attaching a vacuum hose; a nozzle member having an opening formed at a 90 degree angle, such that the opening is operable to be disposed against a floor and a wall simultaneously; brushes disposed along an outer periphery of the opening; an angled edge formed at the 90 degree angle in the nozzle member; and a plurality of internal support pins disposed to support the opening of the nozzle member.

In a further aspect of the present invention, a method for vacuuming comprises attaching a vacuum nozzle to a vacuum hose extension, wherein the vacuum nozzle includes a vacuum hose receptacle for attaching a vacuum hose and a nozzle member having an opening formed at a 90 degree angle; disposing the vacuum nozzle along a 90 degree corner formed along an intersection of two members, where the opening is disposed against each of the two members; and vacuuming both of the two members at the same time by moving the vacuum nozzle along the intersection of the two members.

These and other features, aspects and advantages of the present invention will become better understood with reference to the following drawings, description and claims.

### BRIEF DESCRIPTION OF THE DRAWINGS

FIG. 1 is a perspective view of a vacuum nozzle, in use, according to an exemplary embodiment of the present invention;

FIG. 2 is a front perspective view of the vacuum nozzle of FIG. 1;

FIG. 3 is a back side perspective view of the vacuum nozzle of FIG. 1; and

FIG. 4 is a cross-sectional view taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vacuum nozzle that is angled to be able to vacuum both a floor portion and a floor molding at the same time. Unlike conventional vacuum nozzles that are flat, the nozzle as herein described is angled, typically at 90 degrees, to fit into the corner along where the wall meets the floor. The nozzle can also be used, for example, where the ceiling meets the wall, or any other such corner to provide a vacuum cleaning thereto.

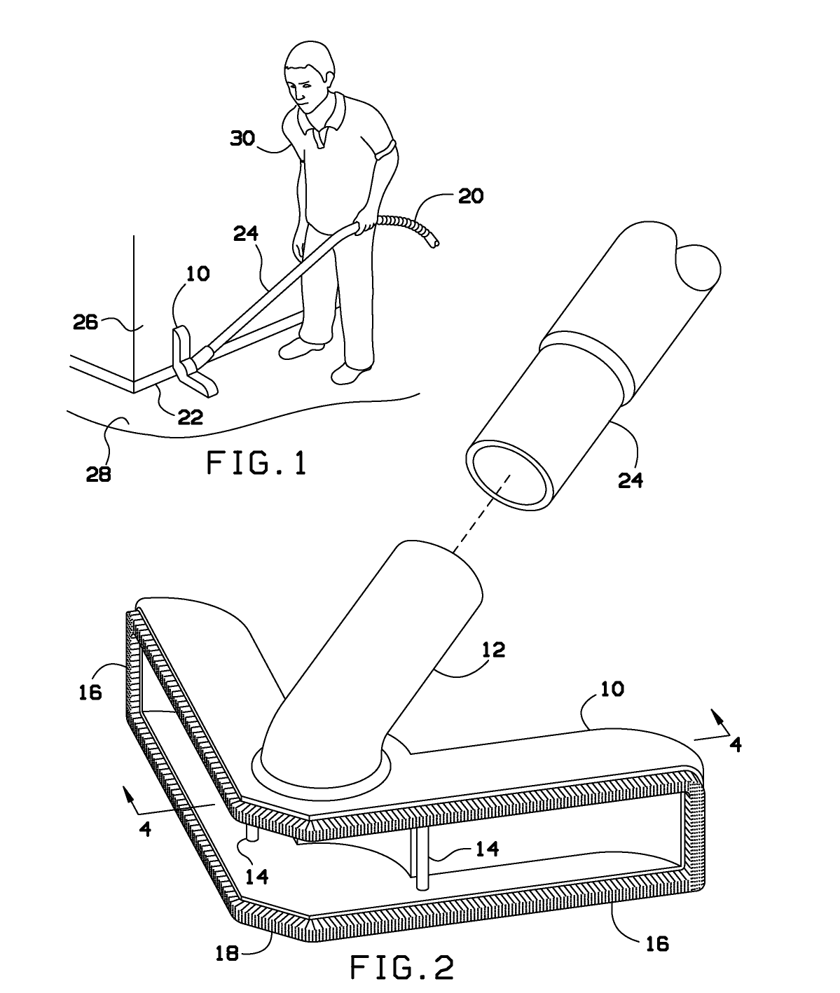

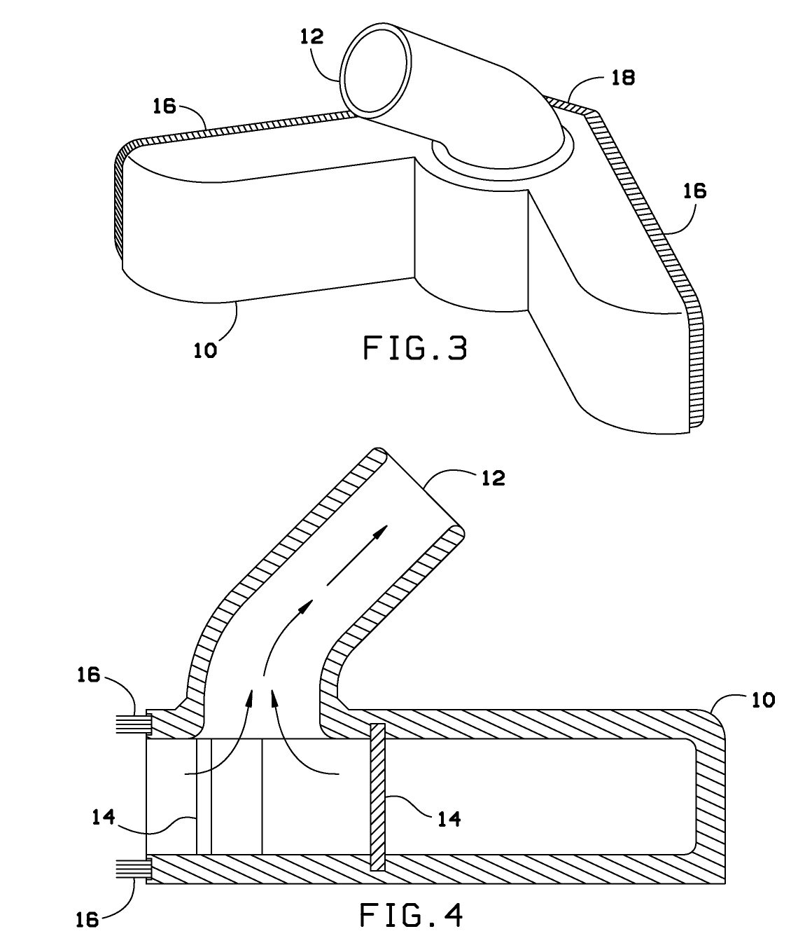

Referring now to FIGS. 1 through 4, a vacuum nozzle 10 includes a vacuum hose receptacle 12 adapted to connect to a vacuum hose extension 24 which may attach to a vacuum hose 20. In some embodiments, the vacuum nozzle 10 may be designed to fit on both the vacuum hose 20 and the vacuum hose extension 24. The vacuum hose receptacle 12 may be designed in various sizes to fit on different vacuum hoses 24. The vacuum hose receptacle 12 may further include various clips and the like to be able to attach to various manufacturers of vacuums that may include a clip mechanism to secure the nozzle onto the vacuum hose.

The vacuum nozzle 10 may be formed at an angle, typically a 90 degree angle, at its opening, to fit into a corner formed by a wall 26 and a floor 28. The wall 26 may include corner molding 22 formed there along and the nozzle 10 may include an angled edge 18, beveling the 90 degree angle of the vacuum nozzle 10, that may accommodate the corner molding 22, as shown in FIG. 1.

The vacuum nozzle 10 may include a plurality of internal support pins to help stabilize the nozzle 14 along its opening.

To use the vacuum nozzle 10, a user 30 may simply move the nozzle 10 along the corner formed by the wall 26 and the floor 28, cleaning both the lower part of the wall 26, the corner molding 22 and the floor 28 (including the very edge of the floor 28) at the same time.

The vacuum nozzle 10 may swivel on the vacuum hose receptacle 12 to permit the vacuum nozzle 10 to be used on both the left hand and the right hand sides of the user 30.

In some embodiments, the vacuum nozzle 10 may be adjustable between an angled vacuum nozzle, as shown in the Figures, and a flat vacuum nozzle. For example, an accordion expansion region may be provided, along with one or more hinges (not shown) to permit the angled vacuum nozzle to expand into a flat vacuum nozzle, thereby allowing the user to use the same nozzle for corner and standard floor cleaning.

Brushes 16 may be formed along an outer periphery of the opening to the vacuum nozzle 10. The brushes 16 may be formed in various shapes and lengths and can be formed of various materials. In some embodiments, the brushes may be about half-inch high soft bristles.

The vacuum nozzle 10 may be made from various materials in various conventional manufacturing processes. For example, the vacuum nozzle 10 may be made from plastic, metal, composite, or the like. Typically, the vacuum nozzle 10 may be made from plastic.

It should be understood, of course, that the foregoing relates to exemplary embodiments of the invention and that modifications may be made without departing from the spirit and scope of the invention as set forth in the following claims.

1. A vacuum nozzle comprising:
a vacuum hose receptacle for attaching a vacuum hose; and
a nozzle member having an opening formed at a 90 degree angle, such that the opening has a floor contacting portion, operable to be disposed against a floor, and a wall contacting portion, operable to be disposed against a wall simultaneously while the floor contacting portion contacts the floor;
an angled edge formed at an outer portion of the nozzle where the floor contacting portion meets the wall contacting portion, the angled edge forming a space such that base molding on the wall does not separate the wall contacting portion from the wall.

2. The vacuum nozzle of claim 1, further comprising brushes disposed along an outer periphery of the opening.

3. (canceled)

4. The vacuum nozzle of claim 1, further comprising a plurality of internal support pins disposed to support the opening of the nozzle member.

5. The vacuum nozzle of claim 1, wherein the vacuum hose receptacle is operable to rotate relative to the nozzle member.

6. A vacuum nozzle comprising:
a vacuum hose receptacle for attaching a vacuum hose;
a nozzle member having an opening formed at a 90 degree angle, such that the opening has a floor contacting portion, is operable to be disposed against a floor, and a wall contacting portion, operable to be disposed against a wall simultaneously while the floor contacting portion contacts the floor;
brushes disposed along an outer periphery of the opening;
an angled edge formed at an outer portion of the nozzle where the floor contacting portion meets the wall contacting portion, the angled edge forming a space such that base molding on the wall does not separate the wall contacting portion from the wall; and
a plurality of internal support pins disposed to support the opening of the nozzle member.

7. The vacuum nozzle of claim 6, wherein the vacuum hose receptacle is operable to rotate relative to the nozzle member.

8. A method for vacuuming comprising:
attaching a vacuum nozzle to a vacuum hose extension, wherein the vacuum nozzle includes a vacuum hose receptacle for attaching a vacuum hose and a nozzle member having an opening formed at a 90 degree angle, the opening having a floor contacting portion, operable to be disposed against a floor, and a wall contacting portion, operable to be disposed against a wall simultaneously while the floor contacting portion contacts the floor;
disposing the vacuum nozzle along a 90 degree corner formed along an intersection of two members, where the opening is disposed against each of the two members;
positioning an angled edge formed at an outer portion of the nozzle where the floor contacting portion meets the wall contacting portion so that the angled edge forms a space such that base molding on the wall does not separate the wall contacting portion from the wall; and
vacuuming both of the two members at the same time by moving the vacuum nozzle along the intersection of the two members.

9. The method of claim 8, wherein the two members are selected from the group consisting of a floor and a wall, a wall and a ceiling, and a wall and a wall.

10. The method of claim 8, further comprising rotating the vacuum hose receptacle relative to the nozzle member to access intersections on both sides of a user.
